(19) United States
(12) Patent Application Publication
(10) Pub. No.: US 2015/0369063 A1
(43) Pub. Date: Dec. 24, 2015

(54) BLADE WHEEL AND METHOD FOR PRODUCING A BLADE THEREFOR

(71) Applicant: SIEMENS AKTIENGESELLSCHAFT, München (DE)

(72) Inventors: Andreas FÖHRIGEN, Berlin (DE); Enno JUNG, Oberhausen (DE); Christian Albrecht KOCH, Mülheim (DE); Udo WEBER, Issum (DE)

(21) Appl. No.: 14/766,830

(22) PCT Filed: Oct. 23, 2013
(86) PCT No.: PCT/EP2013/072125

§ 371 Date: Aug. 10, 2015

(30) Foreign Application Priority Data
Feb. 19, 2013 (EP) 13155707.6

(51) Int. Cl. F01D 5/30; F01D 5/12; F01D 5/32; F01D 5/02

(52) U.S. Cl. CPC F01D 5/3015; F01D 5/02; F01D 5/12; F01D 5/326; F05D 2220/30; F05D 2230/50

(57) ABSTRACT

A turbine blade wheel includes a wheel disk with a disk element (2) including an inlet side (3), an opposite outlet-side (4), substantially axial slots (5) distributed over the disk circumference, and vanes (6) in the slots. Each vane includes a vane root (7), an outlet-side vane root end surface (9) and an inlet-side vane root end surface (8). The vane root (7) is at the inlet side (3) of the disk element (2) for mounting in its respective slot (5). A first bearing plate (12) is provided on the outlet side (4) of the disk element. At least one pressure piece shim (13) is provided in the slot (5). A second bearing plate (14) is provided on the inlet side (3). The disk element (2) is connected to the second bearing plate (14) by a radial connecting element (16) that is pressed to act on the shim in the slot to urge the root of the vane base (7) in the slot (5) to an outermost radial position. Further a method for producing a vane using such a blade wheel is disclosed.

### CROSS-REFERENCE TO RELATED APPLICATIONS

The present application is a 35 U.S.C. §§371 national phase conversion of PCT/EP2013/072125, filed Oct. 23, 2013, which claims priority of European Patent Application No. 13155707.6, filed Feb. 19, 2013, the contents of which are incorporated by reference herein. The PCT International Application was published in the German language.

### TECHNICAL BACKGROUND

The invention relates to a blade wheel particularly for a turbine, the blade wheel, comprising a rotor disk having a disk element. The disk element comprises an inlet side and, opposite the inlet side, an outlet side and a periphery having essentially axial slots distributed over its circumference. Multiple turbine blades are distributed with one in each slot. Each turbine blade is comprised of a blade root, an outlet-side blade root end face and an inlet-side blade root end face. The blade root is to be installed in the respective slot from the inlet side of the disk element. The invention also relates to a method for producing a blade with the aid of such a blade wheel.

In turbines, a flow medium is transported within a flow duct, in order to extract energy from the medium. To that end, turbine blades are arranged in the flow duct. For example, in the flow duct of an axial-flow gas turbine, there are arranged, in alternation and successively in the flow direction, guide vane rings formed of guide vanes and rotor blade rings formed of rotor blades. The guide vanes divert the flow medium in a suitable manner onto the rotor blades which are connected to a rotor which is made to rotate, such that kinetic energy from the flow medium is converted into that rotational energy. Such blades in turbomachines are often subjected to high mechanical loads. Especially at simultaneously high temperature and high rotational speeds, as in a gas turbine, the blade material is subject to high material loading. This can cause cracks to form in the blade material, and the cracks widen over time as loads continue to be applied. Another consequence of the high thermal and mechanical loads is the appearance of deterioration phenomena. For that reason, the blades have to be replaced during an overhaul. However, the dimensions of the gas turbine change during its operation. First, the rotor expands thermally due to centripetal acceleration, which is followed by thermal expansion of the blades. Other phenomena are pressure expansion of the stator and thermal expansion of the stator.

Blades which are manufactured according to reference specifications for a new turbine, that is, an unused turbine, are therefore of the wrong radial direction length. For that reason, the blades have to be ground on-site to their final dimensions, taking into account the geometric dimensions of the used turbine in which the blades are installed. If in addition the blades are ground directly in the blade wheel of the gas turbine, the bad attachment of the blades, which exists when the turbine is not in operation, causes an imprecise finish which is not in accordance with tolerances. For that reason, the blades are often re-measured and re-worked multiple times.

### SUMMARY OF THE INVENTION

A first object of the invention is to provide a blade wheel which minimizes or even avoids the abovementioned problems. A second object of the invention is to produce a blade with the aid of such a blade wheel, in particular a replacement blade during an overhaul of a turbine.

According to the invention, the first object is achieved by providing a blade wheel comprising a rotor disk having a disk element according to the disclosure herein, by means of the following features, wherein
there is a first bearing plate on the outlet side of a disk element, such that the outlet-side blade root end face of a blade at least partially bears against the first bearing plate,
there is at least one pressure piece shim in each slot for for being urged radially outwardly for fixing the blade root of the respective blade in each slot,
there is a second bearing plate on the inlet side of the disk element, such that the inlet-side blade root end face of a blade in its slot at least partially bears against the second bearing plate,
at least the disk element is connected to the second bearing plate by means of an axial direction radial connection element which exerts a force on the disk element, whereby a radially outwardly directed force is transmitted through the pressure piece shim at least from radially below the blade root, whereby the blade root is fixed in a radially outermost position in the slot.

The pressure piece transmits to its blade root the force which results from tightening the respective radial connection element for that root, and thus contributes to the secured, radially outermost position of the respective blade root. The shims also prevent damage to the blade roots, in particular to their coating. The blades are thus securely fixed both axially and radially in their slots. This means that the blades can be finished within the tolerances and deviations due to inadequate fixing no longer appear. The blade wheel according to the invention makes an exact finish possible, as the blades can no longer move within the slots.

Preferably, the first bearing plate bears entirely against the outlet-side blade root end face and/or the second bearing plate bears entirely against the inlet-side blade root end face. This increases the security of the axial fixing.

In a preferred configuration, the second bearing plate is connected to the inlet side of the disk element by releasable attachment elements, in particular screws. Preferably, the first bearing plate is connected to the outlet side of the disk element by non-releasable connection elements. The blade roots may thus be pushed into the slots only from the inlet side. This also avoids the danger of damage to the blade roots due to e.g. further screwing in of the first bearing plate.

According to the invention, the second object is achieved using a method for producing a blade with the aid of a blade wheel as described above, wherein the blade wheel comprises at least one blade to be manufactured, in a current state and with a current length, the method having the following steps:
providing manufacturing specifications by means of a time-discrete model, comprising multiple modelling variables,
manufacturing the at least one blade on the blade wheel to a design state with a design length.

In operation, the dimensions of both the rotor and the surrounding components change, generally as a consequence of the acceleration. For that reason, the blades to be exchanged during an overhaul must be adapted to the new changed conditions. Hitherto, this was possible only with great expenditure. The method according to the invention causes the replacement blades to be ready prior to the turbine overhaul and these ready replacements can be installed directly. This avoids an undesired extension of the overhaul and particularly of the time it requires. If the method is used in conjunction with the blade wheel according to the invention, then all of the blades can be provided with the same length, so that variation in blade length is minimized. Preferably, as an additional step, a current-design deviation, between the current blade length and the design blade length, is determined. It is thus possible to manufacture within tolerances.

Preferably, the changes in the dimensions of the turbine, in particular the dimensions of a turbine gap, have at least a partial influence as a modelling variable. In a preferred configuration, an original, predefined reference value of the blade length has an influence as a modelling variable. These modelling variables make it possible to determine the required blade length particularly well. Other and/or further modelling variables are of course conceivable.

Further features, properties and advantages of the present invention are provided by the description that follows with reference to the accompanying schematic figures, in which:

### BRIEF DESCRIPTION OF THE DRAWINGS

FIG. 1 shows a blade wheel being fitted with blades from the inlet side of the wheel, with the inlet side bearing plate removed,

FIG. 2 shows a partial section of a blade wheel without blades, viewed from the outlet side, and with pressure piece shims installed in the slots,

FIG. 3 shows a partial section of a blade wheel with blades installed, viewed from the inlet side.

### DESCRIPTION OF AN EMBODIMENT

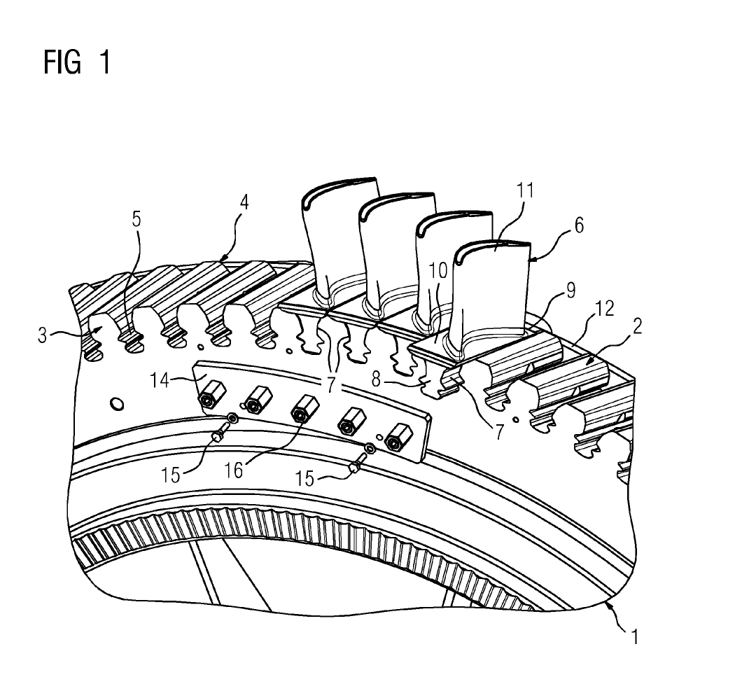

Referring to FIG. 1, a blade wheel according to the invention has a rotor disk 1 with a disk element 2, which comprises an inlet side 3 and an opposite outlet side 4 and essentially axial direction slots 5 distributed around the circumference of the disk element. Furthermore, the blade wheel comprises multiple blades 6, each having a blade root 7, an outlet-side blade root end face 9 and an inlet-side blade root end face 8, a blade root upper surface or platform 10 and a blade upper 11. The blade root 7 is configured to be inserted into the respective slot starting from the inlet side 3 of the disk element 2 and then is secured in the slot 5.

There is a first bearing plate 12 on the outlet side which is shaped as an annulus and is positioned such that the outlet-side blade root end face 9 entirely bears against the first bearing plate 12. However, the outlet-side blade root end face 9 may partially bear against the first bearing plate 12. The first bearing plate 12 is connected to the disk element 2 in a preferably non-releasable connection, e.g. a welded connection.

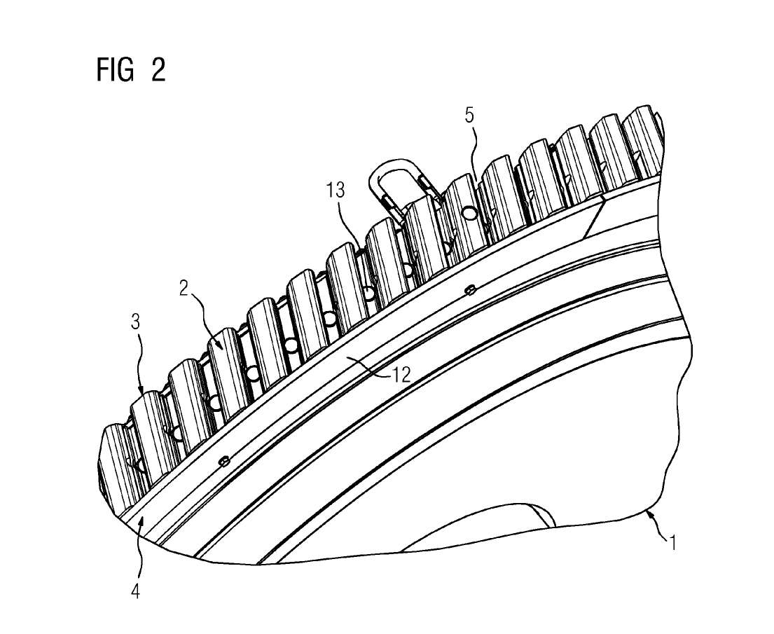

In each slot 5 there are one or two and perhaps more pressure piece shims 13 (FIG. 2) for fixing each blade root 7 radially in its slot 5. The pressure piece shims 13 (FIG. 2) may be comprised of plastic. The shims are pushed axially, with their blade roots 7 moving into the respective slots 5. However, the pressure piece shims 13 (FIG. 2) may be pushed into the slots 5 prior to the blade roots 7, and the blade roots 7 are then pushed in only subsequently. In order for the shims to press radially outwardly on the blade root, each shim is in its slot below the blade root.

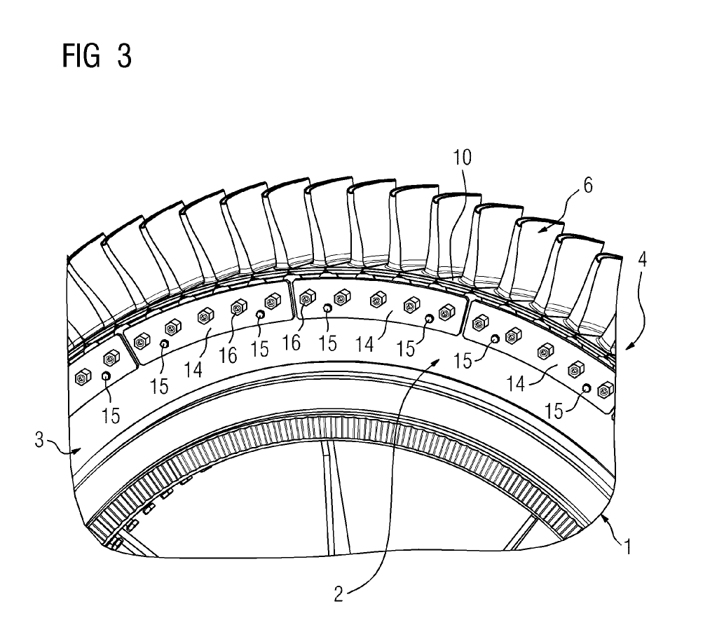

Then, a second bearing plate 14 is mounted on the inlet side of the disk element. One arcuate section of the bearing plate 14 is shown in FIG. 1. A full array of such sections is shown in FIG. 3. Mounting of the arcuate sections of the bearing plate 14 can be effected, for example, by respective screw connections 15 into holes in the disk element. In this embodiment, each inlet-side blade root end face 8 bears entirely against its second bearing plate 14 section (FIG. 3). It is however also conceivable that the inlet-side blade root end face 8 bears only partially against this second bearing plate 14. The plate 14 fixes the blades 6 axially in their slots.

The disk element 2 is also connected to the second bearing plate 14 by radial connection elements 16. In FIG. 1, it can be seen that there is a respective radial connection element 16 on the bearing plate circumferentially and radially located at each blade root. It is also possible for the axial connection elements 16 to be connected to the disk element 2, the second bearing plate 14 and the first bearing plate 12. Tightening of the axial connection elements 16 fixes the respective blade root 7 in the radially outermost position in its slot 5 (FIG. 3). By tightening radial connection element 16 at the blade then being installed or replaced, the connection element 16 is fixed against the second bearing plate 14, creating tension. Attaching and tightening the radial connection element 16 exerts a force on the disk element 2 which presses the respective blade root 7 into radially outermost position in the slot 5 and secures it there. In the disclosed arrangement, the force of the radial connection element being tightened is transmitted by the pressure piece shims 13 in the respective slot 5 (FIG. 2) to the blade 6 or, via the blade root 7. The shims and the connection element 16 engage in the slot to urge the shims radially outward against the blade root in the slot. The shapes of the shims 13 and their location in their slot of the shim, as related to the radial location of the connection element with respect to the shim, either raises or deforms the shims to cause them to press radially outwardly on the blade. At the same time, the pressure piece shims 13 (FIG. 2) ensure that, after the radial connection elements 16 have been tightened, these radial connection elements 16 leave no indentations on the blade roots 7 as only the shims press radially on the blade roots. Thus, the blades 6 are securely fixed axially by the bearing plates and radially by the shims. This means that the blades 6 can be finished within the tolerance and deviations due to inadequate fixing no longer appear.

However, another problem arises from the fact that the dimensions of both the rotor and the surrounding components change, generally due to acceleration of the rotor. The blades 6 now in the previously operated rotor can therefore not be used having the same dimensions as blades in an unused, new turbine. In order to solve this problem, a method is proposed for producing a blade with the aid of a blade wheel. In that context, the blade wheel of the method is the abovementioned blade wheel having a rotor disk 1, disk elements 2 and blades 6. The blade wheel then comprises at least one blade that is to be manufactured in a current state and with a current radial length. The method comprises a first step of providing manufacturing specifications by means of a time-discrete model, comprising multiple modelling variables and comprises a second step of manufacturing the blades 6 with the aid of the time-discrete model to a design state including a design length. In the method, one of the modelling variables is an indication of an original, predefined reference value for the blade length, that is, the original blade length of the blades 6 in a newly built, unused turbine.

A further influencing factor is the turbine gap (not shown) between the blades 6 and a turbine housing (not shown). If the turbine gap is kept to a minimum, the turbine operates at a higher efficiency, since only a minimum quantity of air or exhaust gas escapes between the blades 6 and the housing. However, the gap changes during operation of a rotor. For that reason, further modelling variables include an indication relating to the reduction in the turbine gap (not shown) during operation, the indication relating to the gap width in a new, unused turbine, and the indication relating to the gap width of the gas turbine in the context of an overhaul, that is in the context of a used turbine which is not then in operation. These modelling variables are now used in the time-discrete model to calculate a design blade length. Of course, other modelling variables may also have an influence. Then, the blades 6 are manufactured to this design blade length, in particular by grinding.

The blade wheel according to the invention also makes an exact finish possible, as the blades 6 are prevented from moving within the slots 5. As an additional method step, a current-design deviation, between the current blade length and the design blade length, is determined. This permits a more precise finish within the tolerance range.

By virtue of the method according to the invention, in conjunction with a blade wheel according to the invention, the newly manufactured blades are thus ready to be exchanged prior to a turbine overhaul. This readiness avoids an undesired extension of the overhaul. Moreover, the blade wheel according to the invention makes it possible for the blades 6 to be manufactured within tolerances. The tolerance deviation of the blade length is thus avoided or at least minimized. Moreover, the method according to the invention, in conjunction with the blade wheel according to the invention, ensures that all of the manufactured blades 6 are the same radial length and there is no divergence in the length of the blades 6.

1. A blade wheel, comprising:
a rotor disk having a disk element, the disk element comprising an inlet side on one axial side of the disk element and an outlet side on the opposite axial side of the disk element and having a plurality of essentially axial slots distributed over a circumference of the disk element and respective blades in the slots;
each blade comprises a blade root, having an outlet-side blade root end face on the outlet side of the disk element and an inlet-side blade root end face on the inlet side of the disk element, wherein each blade root is configured to be inserted into and attached in a respective slot from the inlet side of the disk element;
a first bearing plate attached on the outlet side of the disk element, such that the outlet-side blade root end face faces at least partially bear against the first bearing plate;
at least one pressure piece shim in each slot configured for urging the blade root at the shim in the slot radially outwardly for axially and radially fixing the blade root in the respective slot;
a second bearing plate attached on the inlet side of the disk element, such that the inlet-side blade root end face faces at least partially bear against the second bearing plate;
at least the disk element is connected to the second bearing plate by a radial connection element configured and operable to exert force on the disk element for causing a force to be transmitted through the pressure piece shim in the slot onto at least one of the blade roots in the slot, for causing the at least one blade root to be fixed in a radially outermost position in the slot.

2. The blade wheel as claimed in claim 1, wherein the first bearing plate bears entirely against the outlet-side blade root end face and/or the second bearing plate bears entirely against the inlet-side blade root end face.

3. The blade wheel as claimed in claim 1, wherein the axial connection element is also connected to the first bearing plate.

4. The blade wheel as claimed in claim 1, wherein the second bearing plate is connected to the inlet side of the disk element by releasable attachment elements.

5. The blade wheel as claimed in claim 1, further comprising:
the first bearing plate is connected to the outlet side of the disk element by non-releasable connection elements.

6. A method for producing a blade with the aid of a blade wheel as claimed in claim 1, wherein the blade wheel comprises at least one blade to be manufactured, in a current state and with a current length, the method comprising the following steps:
providing manufacturing specifications by means of a time-discrete model, and the model comprising multiple modelling variables; and
manufacturing the at least one blade on the blade wheel to a design state with a design length.

7. The method for producing a blade as claimed in claim 6, further comprising:
as an additional step, determining a current-design deviation between the current blade length and the design blade length.

8. The method for producing a blade as claimed in claim 6, comprising changes in dimensions of the turbine, including dimensions of a turbine gap having at least a partial influence as one of the modelling variables.

9. The method for producing a blade as claimed in claim 6, further comprising using an original, predefined reference value of the blade length as an influence as a modelling variable.

10. The blade wheel as claimed in claim 1, wherein:
the shim is in the slot radially inwardly of the blade root;
a radial connection element extending from the second bearing plate into the slot and positioned and configured to be moved into contact with the shim for causing the shim to operate to urge the blade root to its radially outer position in the slot.
